(19) United States
(12) Patent Application Publication
(10) Pub. No.: US 2015/0346774 A1
(43) Pub. Date: Dec. 3, 2015

(54) LAMP TABLET DOCKING STATION WITH CAM LOCK

(71) Applicants: Christopher Marquardt, Larchmont, NY (US); Roger Henry Gagnon, Larchmont, NY (US)

(72) Inventors: Christopher Marquardt, Larchmont, NY (US); Roger Henry Gagnon, Larchmont, NY (US)

(21) Appl. No.: 14/822,645

(22) Filed: Aug. 10, 2015

Related U.S. Application Data
(63) Continuation-in-part of application No. 13/939,394, filed on Jul. 11, 2013, now Pat. No. 9,103,543.

(51) Int. Cl. G06F 1/16; F21S 6/00; F21V 33/00; F21V 21/26; F21V 21/06

(52) U.S. Cl. CPC G06F 1/1632; F21V 21/26; F21V 21/06; F21V 33/0052; F21S 6/003; F21V 33/0056; F21Y 2101/02

(57) ABSTRACT

A lamp stand docking station. The lamp stand docking station includes a base, where the base is configured to support the lamp stand docking station. The lamp stand docking station also includes a lamp head attached to the base. The lamp head includes a first tread within the lamp head and an adjustable arm for securing an external device. The lamp head also includes a second tread on the adjustable arm, the second tread configured to be pressed against the first tread and a lamp.

### CROSS-REFERENCE TO RELATED APPLICATIONS

This application claims is a continuation in part of, and claims the benefit of and priority to, U.S. Non-Provisional patent application Ser. No. 13/939,394 filed on Jul. 11, 2013, which application is incorporated herein by reference in its entirety.

### BACKGROUND OF THE INVENTION

Connected tablet computing will play a greater role in the entertainment and maintenance of the modern household, but existing device support and positioning solutions limit the solutions possibilities that tablets offer. For example, some tv providers now provide apps or networking that allow subscribers to watch programming on tablets or computers. Thus users may have a tv but rarely watch the actual tv because of the convenience and mobility provided by using a tablet. For instance, a parent may allow children who are not in the home full-time, such as college students to view programming via the parent's subscription, allowing the child to save the money of a redundant subscription.

In addition, tablets have become much more than computing devices. They serve as game devices, messaging centers and serve many other functions. Many users carry tablets with them constantly, using them to serve as multi-purpose devices that allow the user to stay in touch or consume entertainment.

However, this increase usage has led to a number of drawbacks. For example, tablets need to be laid horizontally, a special stand is purchased or improvised to hold the tablet at a desired angle or the user holds the tablet. This tends to mean that the tablet is held in a single position, regardless of circumstances.

Accordingly, there is a need in the art for a device which can safely and flexibly position a tablet computer for hands-free use that is integrated into a basic home appliance without compromising beauty or utility. Moreover, there is a need in the art for a device which enhances the value of tablet computers for many needs around the home, such as home entertainment and telecommunications.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a lamp stand docking station. The lamp stand docking station includes a base, where the base is configured to support the lamp stand docking station. The lamp stand docking station also includes a lamp head attached to the base. The lamp head includes a first tread within the lamp head and an adjustable arm for securing an external device. The lamp head also includes a second tread on the adjustable arm, the second tread configured to be pressed against the first tread and a lamp.

Another example embodiment includes a lamp stand docking station. The lamp stand docking station includes a base, where the base is configured to support the lamp stand docking station. The lamp stand docking station also includes a first arm connected to the base. The lamp stand docking station further includes a second arm movably connected to the first arm. The lamp stand docking station also includes a lamp head attached to the second arm. The lamp head includes a first tread within the lamp head and an adjustable arm for securing an external device. The lamp head also includes a second tread on the adjustable arm, the second tread configured to be pressed against the first tread and a lamp.

Another example embodiment includes a lamp stand docking station. The lamp stand docking station includes a base, where the base is configured to support the lamp stand docking station. The lamp stand docking station also includes a first arm connected to the base. The lamp stand docking station further includes a second arm movably connected to the first arm. The lamp stand docking station also includes a lamp head attached to the second arm. The lamp head is configured to secure an external device. The lamp head includes a first hook, the first hook configured to press against opposing surfaces of an external device such that the external device cannot move in a direction which is perpendicular to either of the opposing surfaces at the location of the first hook. The lamp head also includes a first tread within the lamp head and an adjustable arm. The adjustable arm includes a second hook configured to press against the opposing surfaces of an external device such that the external device cannot move in a direction which is perpendicular to either of the opposing surfaces at the location of the second hook. The adjustable arm also includes a second tread, the second tread configured to be pressed against the first tread. The lamp head further includes a trigger. The trigger is configured to allow motion of the adjustable arm relative to the lamp head in a first position and prevent motion of the adjustable arm relative to the lamp head in a second position. The lamp head additionally includes a lamp, where the lamp is configured to produce light.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a lamp tablet docking station;

FIG. 2 illustrates an example of a base;

FIG. 3A illustrates a front view of an example of a lamp head in use;

FIG. 3B illustrates a rear view of an example of a lamp head in use;

FIG. 4 illustrates a cross-sectional view of the lamp head in a locked position; and

FIG. 5 illustrates a cross-sectional view of the lamp head in an open position.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

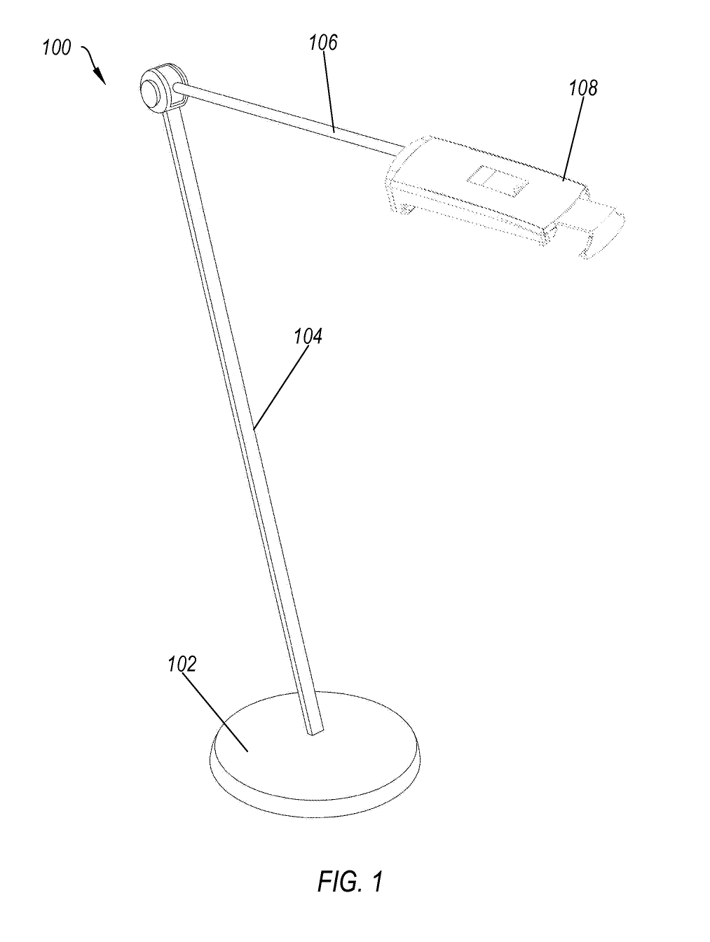

FIG. 1 illustrates an example of a lamp tablet docking station 100. The lamp tablet docking station 100 is a lamp stand that acts as a docking station for a tablet or other external electronic device. I.e., the lamp tablet docking station 100 includes the functionality of a lamp, docking station and flexible stand for an external device.

FIG. 1, shows that the lamp tablet docking station 100 can include a base 102. The base 102 can support lamp tablet docking station 100. I.e., the base 102 can be of sufficient width and strength to support the lamp tablet docking station 100. For example, the base 102 can include ballast configured to allow the base 102 to remain flat on a surface even when one or more elements of the lamp tablet docking station 100 are extended, producing torque on the base. For example, the ballast can include steel, lead, or similar materials and/or a generally planar, flat plate shape to fit within the base. Additionally or alternatively, the base 102 can allow the lamp tablet docking station 100 to be secured to a floor, wall, ceiling or other structure. I.e., the base 102 can include mounting hardware or other mechanisms which allow the base 102 to be secured in a desired area.

FIG. 1 also shows that the lamp tablet docking station 100 can include a first arm 104. The first arm 104 can be secured to the base. I.e., the base can support the first arm 104. The first arm 104 can be movably attached to the base 102. I.e., the position of the first arm 104 relative to the base 102 can be adjusted. For example, the angle of the first arm 104 relative to the base 102 can be adjusted and/or the first arm 102 can be rotated relative to the base 102. E.g., the first arm 104 can be attached to the base 102 using a swivel bracket, hinge, pin or any other desired attachment mechanism. Additionally or alternatively, the first arm 104 can be immobile relative to the base 102. The first arm 104 can include any structural element of sufficient strength to support the other portions of the lamp tablet docking station 100. For example, the first arm 104 can include a rod or multiple parallel rods.

FIG. 1 further shows that the lamp tablet docking station 100 can include a second arm 106. The second arm 106 is movably attached to the first arm 104. I.e., the position of the second arm 106 relative to the first arm 104 can be adjusted. For example, the angle of the second arm 106 relative to the first arm 104 can be adjusted and/or the second arm 106 can be rotated relative to the first arm 104. E.g., the second arm 106 can be attached to the first arm 104 using a swivel bracket, hinge, pin or any other desired attachment mechanism. Additionally or alternatively, the second arm 106 can be immobile relative to the first arm 104. The second arm 106 can include any structural element of sufficient strength to support the other portions of the lamp tablet docking station 100. For example, the second arm 106 can include a rod or multiple parallel rods.

FIG. 1 additionally shows that the lamp tablet docking station 100 can include a lamp head 108. The lamp head 108 can be configured to secure an external device. I.e., the lamp head 108 can allow a user to secure an unsecure an external device. For example, the external device can include a tablet, such as an iPad, electronic book, such as a Kindle or Nook, a cellphone, a laptop, a monitor, a keyboard or any other desired external device. The lamp head 108 can be rotatably attached to the second arm 106. I.e., the orientation of the lamp head 108, including angle, can be changed relative to the second arm 106. Additionally, the lamp head can be used as a standalone light if so desired. I.e., when an external device is not secured in the lamp head 108 the lamp head 108 can be used as an ordinary lamp.

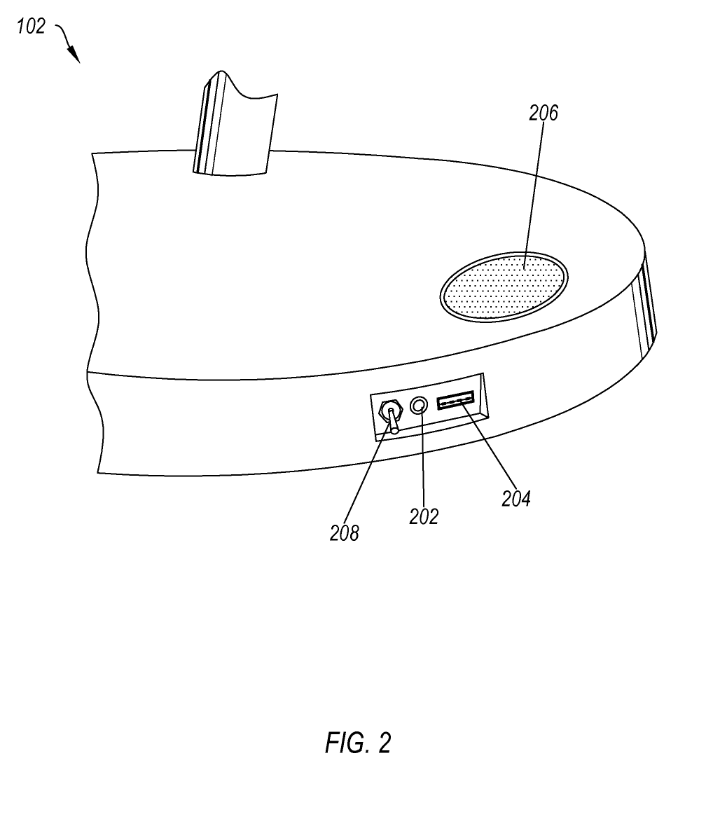

FIG. 2 illustrates an example of a base 102. The base 102 can be configured to support a lamp tablet docking station, such as the lamp tablet docking station 100 of FIG. 1. E.g., the base 102 can allow a lamp tablet data station to be placed in a desired location. For example, the base 102 can be placed on a floor, secured to a surface, such as a wall, placed on the floor or secured in any other desired location.

FIG. 2 shows that the base 102 can include a power supply 202. The power supply 202 can allow electrical power to be supplied to a lamp tablet docking station 100. For example, the power supply 202 can allow the base 102 to be connected to power, such as via an outlet or other power source. Additionally or alternatively, power can be supplied to the base 102 from an internal power source, such as batteries or other power sources.

FIG. 2 also shows that the base 102 can include a data interface 204. The data interface 204 can allow the base to be networked to an external device. For example, the data interface 204 can be attached to a computer, router, printer or any other device. The external device may then be automatically connected to any external device which is secured to a lamp head in a lamp tablet docking station, such as the lamp head 108 of the lamp tablet docking station 100 in FIG. 1. For example, the data interface 204 can include a Universal Serial Bus (USB) connector, an Ethernet connector, or any other desired connector.

FIG. 2 further shows that the base 102 can include a speaker 206. The speakers 206 can include an electroacoustic transducer that converts an electrical signal into sound that can be perceived by a user. Specifically, the speaker 206 can move in accordance with the variations of an electrical signal and causes sound waves to propagate through a medium. In particular, the speaker 206 can be used to produce sound from a data signal sent to the base 102. The speaker 206 can be part of the base 102 or can include an interface that allows for attachment of external speakers such as a headphone jack.

FIG. 2 further shows that the base 102 can include a switch 208. The switch 208 can be configured to control one or more electronic devices within the lamp head 108. For example, the switch 208 can be configured to turn on/off a light within the lamp head, adjust the brightness of the light, change lighting features (i.e. allow for different lights to come on or off for a desired effect), control input or output to the electronic device or control any other desired feature. The switch 208 can be any desired mechanism. For example, the switch 208 can include a push button, toggle switch, sensor (e.g., a light sensor) or any other desired switch.

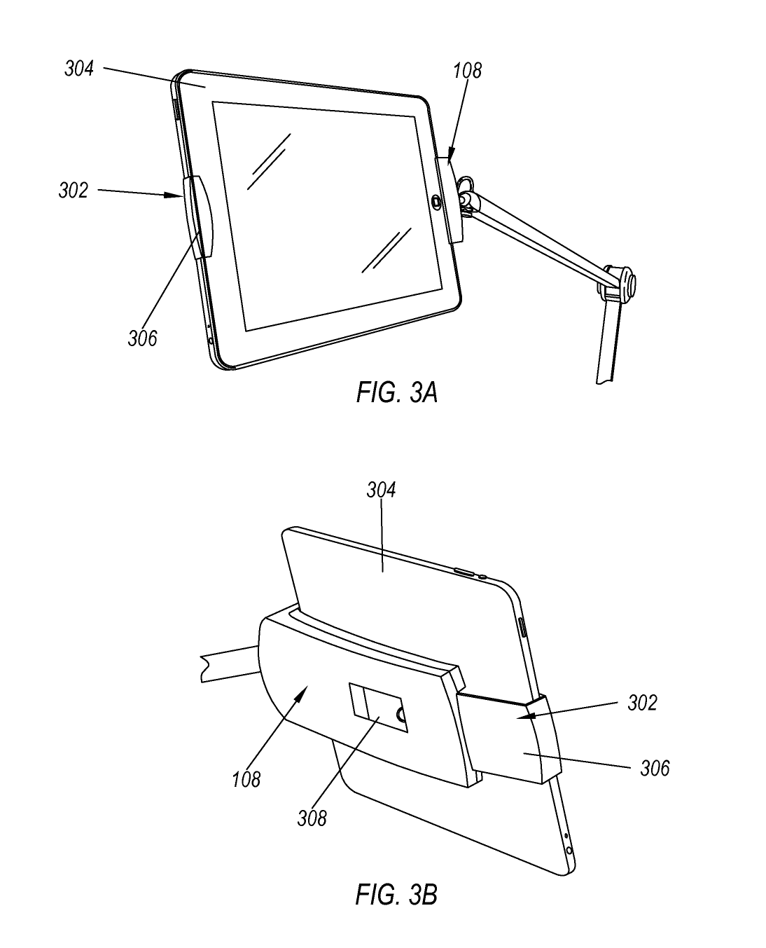

FIGS. 3A and 3B (collectively “FIG. 3”) illustrate an example of a lamp head 108 in use. FIG. 3A illustrates a front view of an example of a lamp head 108 in use; and FIG. 3B illustrates a rear view of an example of a lamp head 108 in use. The lamp head 108 can be used to secure an external device to a lamp tablet docking station, such as the lamp tablet docking station 100 of FIG. 1. For example, the external device can include a tablet or other electronic device.

FIG. 3 shows that the lamp head 108 can include a securing mechanism 302. The securing mechanism 302 can include any device configured to secure an external device 304 within the lamp head 108. For example, the securing mechanism 302 can include a hook or lip configured to be placed around the external device 304.

FIG. 3 also shows that the lamp head 108 can include an adjustable arm 306. The adjustable arm 306 can be configured to allow the user to change the position of the securing mechanism 302. I.e., the adjustable arm 306 can allow the user to configure the securing mechanism 302 to match the dimensions of the external device 304.

FIG. 3 further shows that the securing mechanism 302 can include a trigger 308. The trigger 308 can be configured to release the adjustable arm 306. I.e., the trigger 308 can be pulled away from the housing in order to release the lamp head 108 and release the external device 304. Likewise, the trigger 308 can be placed flush with the housing and any reduction in lamp head size remains possible but increase in lamp head size is hindered. This, the user can fully configure the size of the lamp head 108 in order to accommodate different external devices 304 be setting the size with the trigger 308.

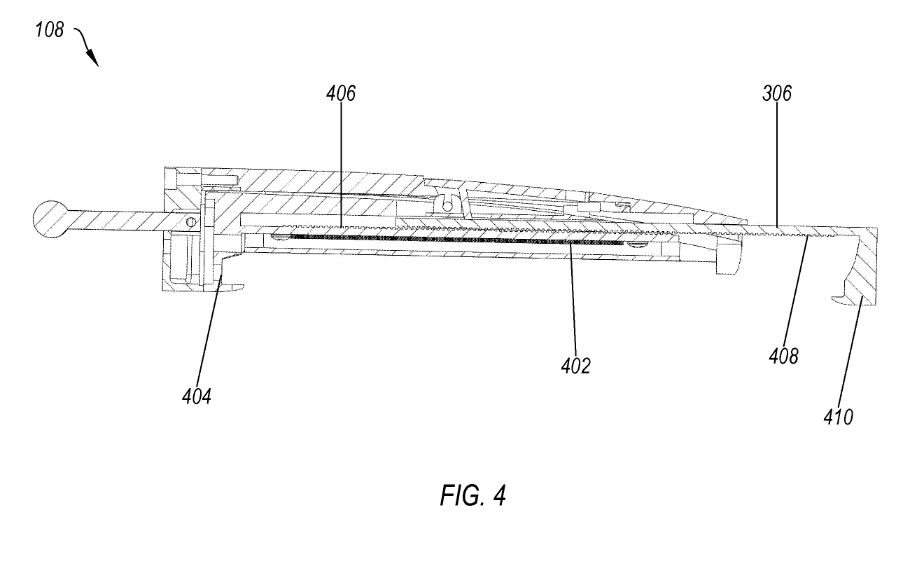

FIG. 4 illustrates a cross-sectional view of the lamp head 108 in a locked position. The lamp head 108 can be configured to secure an external device. Additionally or alternatively, the lamp head 108 can be moved to allow a user to position the external device in any desired orientation. When in the locked position the lamp head 108 secures the external device without any assistance from a user. That is, the user can leave the external device in the locked lamp head 108 and the lamp head 108 will secure the external device.

FIG. 4 shows that the lamp head 108 can include a lamp 402. The lamp 402 can include any type of light source including, incandescent, fluorescent, compact fluorescent, LED, LCD or any other desired light source. The lamp 402 can allow the lamp head 108 to be used as a lamp when an external device is not secured in the lamp head 108. I.e., the lamp head 108 can be a lamp which is configured to also secure an external device.

FIG. 4 also shows that the lamp head 108 can include a data port 404. The data port 404 can be configured to electrically connect the external device to the lamp head 108. I.e., the data port 404 can allow the external device to receive power from the lamp head 108. Additionally or alternatively, the data port 404 can allow anything connected to the lamp head 108 to be electrically connected to the external device. For example, the data port 404 can connect the external device to a computer or other device through the data interface 204 of FIG. 2.

FIG. 4 further shows that the lamp head 108 can include a first tread 406. The first tread 406 is a grooved surface which has a high coefficient of friction. That is the first tread 406 creates a high friction surface. This allows the securing mechanism to remain in the set state. I.e., when the user sets the position of the adjustable arm 306 the first tread 406 secures the position until released by the user, as described below. The first tread 406 is a flat surface and oriented upward in the view of FIG. 4.

FIG. 4 additionally shows that the lamp head 108 can include a second tread 408. The second tread 408 is on the bottom of the adjustable arm 306. The second tread 408 may be complimentary to the first tread 406. That is, the second tread 408 may have an opposing pattern of the first tread 406 such that in certain positions the second tread 408 and the first tread 406 interlock with one another. This can further increase the friction between the first tread 406 and the second tread 408, especially when pressed against one another.

FIG. 4 moreover shows that the trigger 308 can press the first tread 406 against the second tread 408. Pressing the first tread 406 against the second tread 408 can increase the friction (which is proportional to the normal force between two surfaces) and, therefore, the force required to move the adjustable arm 306 relative to the lamp head 108. That is the trigger 308 can produce friction which prevents motion of the adjustable arm 306 relative to the lamp head 108.

FIG. 4 also show that the lamp head 108 can include a hook 410. The hook 410 includes a mechanism that passes around the eternal device preventing movement of the external device along one axis. That is, the hook 410 presses against opposing surfaces of the external device such that the external device cannot move in a direction which is perpendicular to either of the opposing surfaces. The hook 410 can be configured to receive external devices of different sizes. For example, the hook 410 can be adjustable or can include padding or other materials.

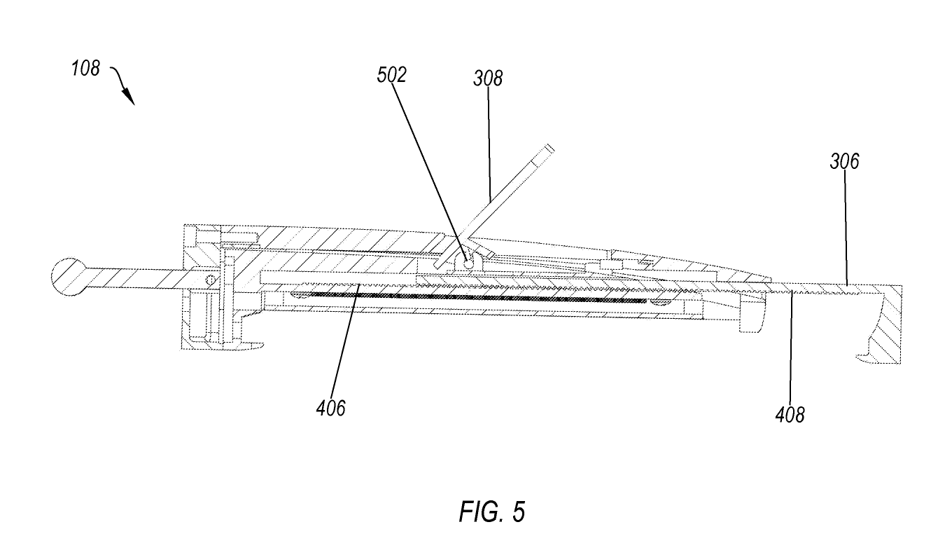

FIG. 5 illustrates a cross-sectional view of the lamp head 108 in an open position. When in the open position the lamp head 108 does not secure the external device. That is, the user can place the lamp head 108 in the open position and move the adjustable arm 306 relative to the lamp head 108, removing the external device.

FIG. 5 shows that trigger 308 can rotate about the fulcrum 502 from the closed position to the open position. Thus, the trigger 308 no longer presses the first tread 406 against the second tread 408. No longer pressing the first tread 406 against the second tread 408 can decrease the friction (which is proportional to the normal force between two surfaces) and, therefore, the force required to move the adjustable arm 306 relative to the lamp head 108. That is the trigger 308 no longer produces friction allowing motion of the adjustable arm 306 relative to the lamp head 108.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A lamp stand docking station, the lamp stand docking station comprising:
a base, wherein the base is configured to support the lamp stand docking station; and
a lamp head attached to the base, wherein the lamp head includes:
a first tread within the lamp head;
an adjustable arm for securing an external device;
a second tread on the adjustable arm, the second tread configured to be pressed against the first tread; and
a lamp.

2. The lamp stand docking station of claim 1, wherein the base includes ballast.

3. The lamp stand docking station of claim 1, wherein the base is configured to be attached to a surface.

4. The lamp stand docking station of claim 3, wherein the surface includes a wall.

5. The lamp stand docking station of claim 1, wherein the base includes a power supply.

6. The lamp stand docking station of claim 5, wherein the power supply includes a plug configured to be inserted into an outlet.

7. The lamp stand docking station of claim 1, wherein the base includes a data interface.

8. The lamp stand docking station of claim 7, wherein the data interface includes a USB port.

9. The lamp stand docking station of claim 1, wherein the base includes a speaker.

10. The lamp stand docking station of claim 1, wherein the lamp includes an LED.

11. A lamp stand docking station, the lamp stand docking station comprising:
a base, wherein the base is configured to support the lamp stand docking station;
a first arm connected to the base;
a second arm movably connected to the first arm; and
a lamp head attached to the second arm, wherein the lamp head includes:
a first tread within the lamp head;
an adjustable arm for securing an external device;
a second tread on the adjustable arm, the second tread configured to be pressed against the first tread; and
a lamp.

12. The lamp stand docking station of claim 11, wherein the second arm is attached to the first arm by a swivel bracket.

13. The lamp stand docking station of claim 11, wherein the second arm is attached to the first arm by a hinge.

14. The lamp stand docking station of claim 11, wherein the second arm is attached to the first arm by a pin.

15. The lamp stand docking station of claim 11, wherein the adjustable arm includes a hook.

16. A lamp stand docking station, the lamp stand docking station comprising:
a base, wherein the base is configured to support the lamp stand docking station;
a first arm connected to the base;
a second arm movably connected to the first arm; and
a lamp head attached to the second arm, wherein the lamp head:
is configured to secure an external device; and
includes:
a first hook, the first hook configured to press against opposing surfaces of an external device such that the external device cannot move in a direction which is perpendicular to either of the opposing surfaces at the location of the first hook;
a first tread within the lamp head;
an adjustable arm, wherein the adjustable arm includes:
a second hook, the second hook configured to press against the opposing surfaces of an external device such that the external device cannot move in a direction which is perpendicular to either of the opposing surfaces at the location of the second hook; and
a second tread, the second tread configured to be pressed against the first tread;
a trigger, the trigger configured to:
allow motion of the adjustable arm relative to the lamp head in a first position; and
prevent motion of the adjustable arm relative to the lamp head in a second position; and
a lamp, wherein the lamp is configured to produce light.

17. The lamp stand docking station of claim 16, wherein the trigger includes:
a fulcrum, the fulcrum configured to allow the user to rotate a at least a portion of the trigger relative to the lamp head.

18. The lamp stand docking station of claim 16, wherein the trigger is further configured to:
press the first tread and the second tread together.

19. The lamp stand docking station of claim 16 further comprising:
a data port, wherein the data port is configured to electrically connect the external device to the lamp head.

20. The lamp stand docking station of claim 16 further comprising:
a switch, wherein the switch is configured to control the operation of the lamp.
